(19) United States
(12) Patent Application Publication
(10) Pub. No.: US 2017/0168483 A1
(43) Pub. Date: Jun. 15, 2017

(54) METHOD AND DEVICE FOR RECEIVING DATA VALUES AND FOR OPERATING A VEHICLE

(71) Applicant: Robert Bosch GmbH, Stuttgart (DE)

(72) Inventors: Moritz Michael Knorr, Hildesheim (DE); Alexander Geraldy, Hildesheim (DE); Christian Skupin, Garbsen (DE); Daniel Zaum, Sarstedt (DE); Emre Cakar, Sarstedt (DE); Hanno Homann, Hannover (DE); Holger Mielenz, Ostfildern (DE); Isabella Hinterleitner, Hildeshiem (DE); Jochen Marx, Emmerke (DE); Lukas Klejnowski, Hannover (DE); Markus Langenberg, Hannover (DE); Michael Pagel, Ludwigsburg (DE)

(21) Appl. No.: 15/376,316

(22) Filed: Dec. 12, 2016

(30) Foreign Application Priority Data
Dec. 14, 2015 (DE) 10 2015 225 161.6

(51) Int. Cl. G05D 1/00; B60W 50/14; G01C 21/34

(52) U.S. Cl. CPC G05D 1/0061; G01C 21/3461; B60W 50/14; B60W 2550/40

(57) ABSTRACT

A method and device for operating at least one first automated vehicle including receiving data values, which represent at least one transition from an automated operation of at least one second automated vehicle to a manual operation of the at least one second automated vehicle, and operating the at least one first automated vehicle, the operation taking place as a function of the received data values.

### RELATED APPLICATION INFORMATION

The present application claims priority to and the benefit of German patent application no. 10 2015 225 161.6, which was filed in Germany on Dec. 14, 2015, the disclosure of which is incorporated herein by reference.

### FIELD OF THE INVENTION

The present invention relates to a method for receiving and processing data values, these data values being related to control transitions during automated driving. The present invention also relates to a receiving unit as well a device for operating an automated vehicle.

### BACKGROUND INFORMATION

German patent document DE 10 2012 112 802 A1 discusses a method for controlling a vehicle, which includes a driver assistance system enabling autonomous, semi-autonomous and manual driving, a surroundings detection unit, an evaluation unit for evaluating the surroundings data generated by the surroundings detection unit for assessing the surroundings situation of the vehicle, and a hazard warning device controllable by the driver assistance system during autonomous or semi-autonomous driving for outputting a warning signal as a take-over prompt to the driver as a function of the assessment of the surroundings situation of the vehicle. In the process, the take-over probability, with which a driver intervention will soon likely be required, is determined with the aid of a risk assessment unit on the basis of the surroundings data and from driving-dynamics data of the vehicle during the autonomous or semi-autonomous driving. In addition, the driver's attention level is estimated with the aid of an attention estimation unit and, finally, a period of time until the warning signal is generated is determined from the take-over probability as a function of the driver's attention level.

### SUMMARY OF THE INVENTION

The method according to the invention for operating at least one first automated vehicle, and the device provided therefor, assume that data values are received, which represent at least one transition from an automated operation of at least one second automated vehicle to a manual operation of the at least one second automated vehicle. In addition, the at least one first automated vehicle is operated as a function of the received data values.

The first vehicle described herein is a vehicle, which may be operated both manually, i.e., for example, by a driver, or also remotely controlled, as well as semi-automated or highly automated. A semi-automated or highly automated operation of a vehicle may be understood to mean both individual driver assistance functions such as, for example, an assistance during parking, as well as fully automated operations, such as longer drives on freeways, country roads or also in intra-urban areas.

A transition from an automated operation of a vehicle to a manual operation is understood to mean the taking control of the operation of the vehicle by a person, regardless of the type, duration, reason and extent of the automated operation previously taking place.

The advantage of operating the automated vehicle as a function of the received data values is demonstrated primarily in that both the safety for the vehicle and, thus, the safety for the occupants and/or the load, as well as the comfort during the use and operation of the vehicle, is increased. This is demonstrated by the fact, for example, that automated driver assistance functions, which are usually associated with computing effort and large amounts of data, are able to respond early to imminent transitions and may be optimized with respect to the consumption of computing capacity. This has advantages, on the one hand, for the speed at which such functions are carried out, which ultimately in turn mean advantages for safety, since driver assistance functions carried out more rapidly also always mean a more rapid response of the vehicle in emergency situations, as well as advantages in the consumption of (electrical) energy, since the latter may be reduced. This is of very great significance for vehicles in general and for electric vehicles in particular. The data values may include location data, which represent a locating of the at least one second automated vehicle during the at least one transition.

In addition to the aforementioned transitions, which are a function of an impermanent condition of surroundings such as, for example, weather conditions, darkness, construction sites, traffic conditions, or events which make normal traffic impossible, it is also important to be aware of permanent surroundings conditions, in particular, which necessitate a transition from an automated operation to a manual operation. This may involve, for example, various components of the traffic infrastructure which require a manual operation. Other examples would be certain landscape features such as, for example, lakes, which lie very close to a narrow road or drives through mountain landscapes with precipices, which also require particular caution during driving and an exact awareness of the position of a vehicle relative to the road and lake or precipice. Thus, it is very important when detecting the necessity of a transition, to know a location of the vehicle which may be for each transition in order to also be able to analyze that aspect of the exact surroundings.

The data values may be received as a digital map.

This has the great advantage that such a map which, among other things, includes transitions, may be integrated into and utilized by maps or navigation systems already present in a vehicle.

The data values may be received directly from an external data cloud, in particular, with the aid of a satellite connection and/or a mobile radio connection and/or a car-2-car connection and/or another data values transmission link, and/or indirectly, in particular, with the aid of a car-2-car link via at least one third vehicle and/or with the aid of a data values transmission medium and/or with the aid of a car-2-infrastructure link.

A car-2-infrastucture (C2X-) link arrangement the receiving of data originating from any arbitrary location, except from other vehicles. This may mean, for example, bridges with corresponding transmitters as a transmission location, or also radio stations, radio towers, or other facilities may be present which are both stationary and non-stationary.

The advantage of a direct connection is the speed at which the data may be transmitted and received. An indirect connection is advantageous if a data transmission is not directly possible as a result of external circumstances such as, for example, when driving through a valley, through a tunnel or in the case of a non-functioning transmission arrangement.

In one particularly specific embodiment, the operation takes place in such a way that a potential transition from an automated operation of the at least one first automated vehicle to a manual operation of the at least one first automated vehicle is detected as a function of the received data values and at least one signal is generated.

By generating a signal as a function of the received data values, it is possible to advantageously control driver assistance functions as well as to inform potential operators of the vehicle. This permits a versatile utilization of the received data values for operating the vehicle, for example, an increase of safety, of stability of the individual function and/or also of the vehicle per se, of the comfort during operation of the vehicle and/or also of the performance of the vehicle.

The operation may take place in such a way that the at least one signal indicates decision-making options for the further operation of the at least one first automated vehicle as a function of the received data values.

The indication or provision of decision-making options means both the provision of decision-making options in the form of parameters or data in general, as well as the provision of decision-making options for one or multiple operators of the automated vehicle. Indications in the form of parameters or data in this case is understood to mean that these parameters or data may, for example, be processed and utilized by arbitrary driver assistance functions. The provision for one or multiple operators is understood to mean, for example, a list with decision-making options, which is made available to the operators. This, in turn, may be accomplished by a visual display, for example, the selection options capable of being selected by a corresponding input device.

The provision of decision-making options increases both the acceptance of such a method and also the acceptance of automated driving per se since, as previously described, the awareness of any imminent transitions includes safety-relevant and comfort-relevant aspects.

The operation may take place in such a way that at least one trajectory for the at least one first automated vehicle is calculated as a function of the received data values.

A trajectory for an automated vehicle may be understood to mean both a longer route, as well as short distances such as, for example, during a parking operation. It is also possible in this case, based on the received data values, to recalculate or optimize arbitrary driver assistance functions which, when they are implemented, either calculate trajectories themselves or resort to calculated or predefined trajectories.

By calculating and planning a trajectory as a function of the received data values, it is advantageously possible to respond to potential transitions already at an early stage by using these already for planning a particular route. In this way, potential responses, whether by an operator of the automated vehicle or also by driver assistance functions, may, for example, be calculated or planned accordingly very early on and with greater relevance for, among other things, safety, comfort and/or performance.

In one particularly specific embodiment, the at least one trajectory is calculated in such a way that the number of transitions from an automated operation of the at least one first automated vehicle to a manual operation of the at least one first automated vehicle is taken into consideration, in particular, minimized.

This reflects the advantage that adapting the trajectory to be calculated to the number of possible transitions provides an additional decision-making option for the selection of a trajectory. This selection may therefore be even better adapted to the needs of an operator of the automated vehicle. An important aspect in this case could be the planning of a route, in which no transition from an automated operation to a manual operation takes place. This would permit operators of trucks, for example, to drive longer distances at one stretch, since sufficient rest times could be included despite a continuous driving. The additional time which can be utilized during driving could, in general, increase immensely the productivity and, ultimately, the acceptance of automated driving by potential operators.

The device according to the present invention for operating at least one first automated vehicle includes, on the one hand, receiving arrangement for receiving data values, which represent at least one transition from an automated operation of at least one second automated vehicle to a manual operation of the at least one second automated vehicle and, on the other hand, an other arrangement for operating the at least one first automated vehicle, the operation taking place as a function of the received data values.

The receiving arrangement may be configured to receive the data values from an external data cloud directly, in particular, with the aid of a satellite connection and/or a mobile radio connection and/or a car-2-car connection and/or another data values transmission link, and/or indirectly, in particular with the aid of a car-2-car connection via at least one third vehicle and/or with the aid of a data values transmission medium.

In one particularly specific embodiment, the arrangement for operating the at least one first automated vehicle are configured in such a way that via a potential transition from an automated operation of the at least one first automated vehicle to a manual operation of the at last one first automated vehicle, at least one signal is generated as a function of the received data values, the at least one signal being capable of indicating decision-making options for the further operation of the at least one first automated vehicle.

The arrangement for operating the at least one first automated vehicle may be configured in such a way that at least one trajectory for the at least one first automated vehicle is calculated as a function of the received data values, whereby the trajectory is calculated in such a way that the number of transitions from an automated operation of the at least one first automated vehicle to a manual operation of the at least one first automated vehicle is taken into consideration, in particular, minimized.

Advantageous refinements of the present invention are specified in the subclaims and presented in the description.

Exemplary embodiments of the present invention are depicted in the drawings and are explained in greater detail in the following descriptions.

### BRIEF DESCRIPTION OF THE DRAWINGS

FIG. 1 shows, purely as an example, a vehicle which carries a device according to the present invention for carrying out a method according to the present invention.

FIG. 2 shows, purely as an example, one exemplary embodiment in the form of a flow chart of the method according to the present invention using a device according to the present invention.

FIG. 3 shows, purely as an example, an exemplary embodiment in the form of a flow chart of a method according to the present invention using a device according to the present invention.

### DETAILED DESCRIPTION

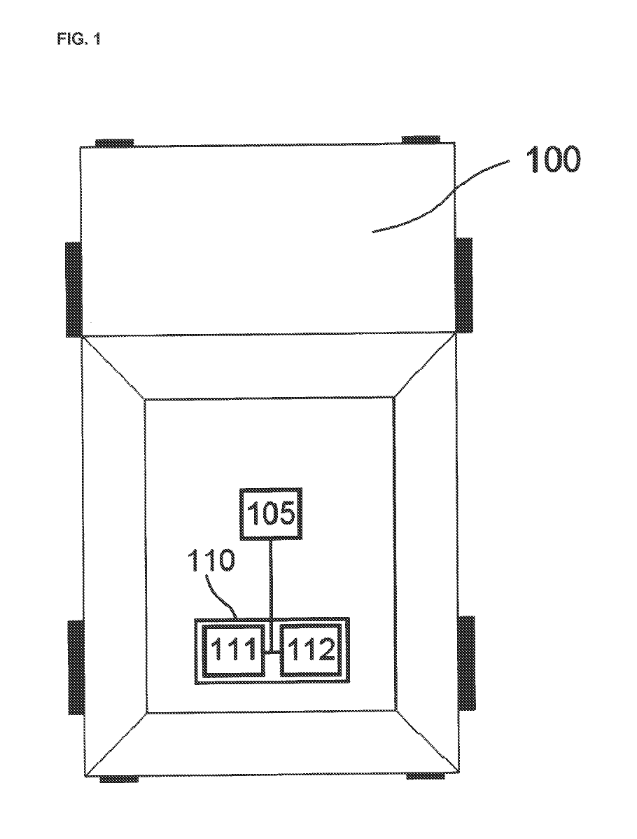

FIG. 1 shows an automated vehicle 100 which carries a possible device 110 according to the present invention for receiving data values and for operating an automated vehicle 100. Device 110 in this case includes receiving arrangement 111, which is configured to receive data values.

These data values include information about potential transitions from an automated operation of an automated vehicle to a manual operation. This involves information, which has already been collected in advance by at least one other vehicle. This at least one other vehicle in this case is equipped, for example, with a corresponding system, which enables it to detect transitions and to store them as data values. These data values, in turn, are sent to an external data source, for example, so that they may be received by automated vehicle 100 with the aid of receiving arrangement 111.

The fundamental idea is that other vehicles, such as automated vehicle 100, may resort to these data values in order to benefit from the information contained in these data values. This information may be used for planning a route as well as, for example, for warning a driver of automated vehicle 100 of an imminent transition in a timely manner.

The receiving of data values may be understood to mean both the receiving from the external data source and also the possibly necessary preparation and forwarding of the data values to an arrangement provided therefor such as, for example, the arrangement for operating the at least one automated vehicle 112, referred to hereinafter as arrangement for operation.

Arrangement for operation 112 in this case are configured in such a way that they enable an operation of automated vehicle 100 on the basis of the data values. Implementation of other driver assistance functions may also be supported on the basis of the received data by connecting arrangement for operation 112 to an other arrangement, for example, control units 105. This may involve, for example, the calculation of a trajectory by a navigation system, the route calculated by the navigation system being adapted on the basis of the data values, so that the transitions contained in the data values are taken into consideration.

In addition, arrangement for operation 112 of automated vehicle 100 are configured in such a way that a driver of automated vehicle 100, who temporarily surrenders the control of automated vehicle 100 to vehicle 100, is generally informed about an imminent transition from an automated operation of vehicle 100 to a manual operation of automated vehicle 100. Moreover, the driver of automated vehicle 100 may be warned in the event the transition must very rapidly take place. In such a case, the warning could, for example, be carried out in such a way that the signal is very obtrusively generated, for example, in the form of a haptic signal and/or a visual signal and/or an acoustic signal, whereas a signal for informing is less obtrusive, for example, quieter. A warning may occur, for example, in the event of a transition taking place in the immediate future and/or taking place in such a way that one or multiple driver assistance functions fail and a manual operation by the driver is essential in order not to jeopardize the safety of vehicle 100 and the potential occupants.

In addition, the driver of automated vehicle 100 may also be provided choices with respect to the further course of action, which result due to the upcoming transition. In such a case, corresponding choices may, for example, be displayed with the aid of a human-machine interface and an input in this regard may be carried out. The human-machine interface may, for example, be a touch screen display.

When operating automated vehicle 100 with the aid of the human-machine interface, for example, by operating the touch screen display, it is also possible to use the data values in order to provide an alternative operation to the conventional operating such as, for example, with the aid of the steering wheel and the gas pedal. In this case, automated vehicle 100 is operated or controlled with the aid of an input such as, for example the selection of the options “Please turn left at the next intersection” or “Reduce speed to 50 km/h.” The received data values in this case are used, for example, to detect when the operation with the aid of the selection of options reaches its limits, and a transition from an automated operation to a manual operation of automated vehicle 100, for example in the form of a conventional operation with the aid of the steering wheel and the gas pedal, is essential in order not to jeopardize the safety of automated vehicle 100 and its occupants.

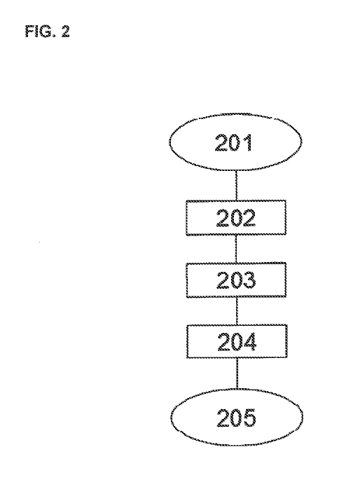

FIG. 2 describes a flow chart of a possible exemplary embodiment of a method according to the present invention and a possible use of a device (110) for an automated vehicle (100).

In step 201, the method starts by operating automated vehicle (100) in an automated manner, for example, and thus, activating device 110 for receiving data values and for operating at least one automated vehicle 100, so that transitions from an automated operation to a manual operation of automated vehicle 100 may be detected in a timely manner on the basis of the received data values. These data values have already been collected in advance by at least one other vehicle, as a result of transitions having taken place with this vehicle itself and the corresponding information has been stored in the form of data values and, for example, has been transferred to an external data memory. These data values may then be received by automated vehicle 100 from this external data memory.

In step 202, the data values are received with the aid of receiving arrangement 111, these received data values including the transitions as well as location data on the included transitions.

In step 203, a signal is generated with the aid of an arrangement for operation 112 of automated vehicle 100 on the basis of the received data values, which informs a user of automated vehicle 100, referred to hereinafter as “driver”, that a transition from an automated operation of automated vehicle 100 to a manual operation of automated vehicle 100 is necessary.

In step 204, automated vehicle 100 signals a release of the control of automated vehicle 100 to an operator or driver of automated vehicle 100. The take-over of vehicle 100 may take place, for example, on the basis of a certain driving behavior of the driver. This may involve the touching of the steering wheel and/or of the gas pedal or clutch pedal.

In step 205, the method ends as a result of automated vehicle 100 having surrendered the control of automated vehicle 100.

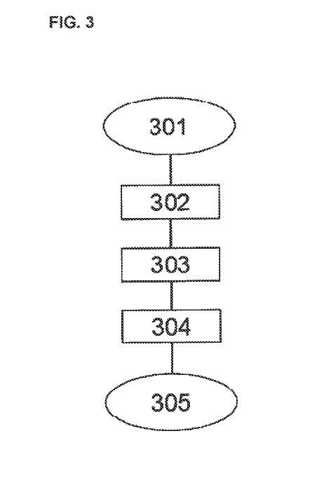

FIG. 3 describes a flow chart of a possible exemplary embodiment of a method according to the present invention and a possible use of a device 110 for an automated vehicle 100.

In step 301, the method starts, for example, by ascertaining a request of a navigation device 105 to device 110 for receiving data values and operating at least one automated vehicle 110.

In step 302, data values are received with the aid of receiving arrangement 111, these received data values including transitions from an automated operation to a manual operation of automated vehicle 100 as well as location data on the included transitions. These data values may, for example, be received in the form of a map, which is saved and integrated into an already existing map, for example, of navigation system 105.

A map in this case may be understood to mean both a visual medium as well as data, which are present, for example, in a memory of a processing unit, in order to create a (digital) map or in order to carry out map-based arithmetic operations such as, for example, the calculation of a route.

In step 303, a route is calculated as a function of the received data values with the aid of a navigation system 105 present in automated vehicle 100.

The route in this case is calculated in such a way that the number of transitions from an automated operation of the at least one first automated vehicle 100 to a manual operation of the at least one first automated vehicle 100 is minimized.

In step 304, the route calculated according to step 303 is transmitted to navigation system 105.

In step 305, the method ends.

What is claimed is:

1. A method for operating at least one first automated vehicle, the method comprising:
receiving data values, which represent at least one transition from an automated operation of at least one second automated vehicle to a manual operation of the at least one second automated vehicle; and
operating the at least one first automated vehicle, the operation taking place as a function of the received data values.

2. The method of claim 1, wherein the data values include location data, which represent a locating of the at least one second automated vehicle during the at least one transition.

3. The method of claim 1, wherein the data values are received as a digital map.

4. The method of claim 1, wherein the data values are received directly from an external data cloud, in particular, with the aid of a satellite connection and/or a mobile radio connection and/or a car-2-car connection and/or another data values transmission link, and/or indirectly, in particular, with the aid of a car-2-car connection via at least one third vehicle and/or with the aid of a data values transmission medium and/or with the aid of a car-2-infrastructure connection.

5. The method claim 1, wherein the operation takes place in such a way that a potential transition from an automated operation of the at least one first automated vehicle to a manual operation of the at least one first automated vehicle is detected and at least one signal is generated as a function of the received data values.

6. The method of claim 5, wherein the operation takes place in such a way that the at least one signal indicates decision-making options for the further operation of the at least one first automated vehicle as a function of the received data values.

7. The method of claim 1, wherein the operation takes place in such a way that at least one trajectory for the at least one first automated vehicle is calculated as a function of the received data values.

8. The method of claim 7, wherein the at least one trajectory is calculated in such a way that the number of transitions from an automated operation of the at least one first automated vehicle to a manual operation of the at least one first automated vehicle is taken into consideration, in particular, is minimized.

9. A device for operating at least one first automated vehicle, comprising:
a receiving arrangement for receiving data values, which represent at least one transition from an automated operation of at least one second automated vehicle to a manual operation of the at least one second automated vehicle; and
an operating arrangement for operating the at least one first automated vehicle, the operation taking place as a function of the received data values.

10. The device of claim 9, wherein the receiving arrangement are configured to receive the data values from an external data cloud directly, in particular, with the aid of a satellite connection and/or a mobile radio connection and/or a car-2-car connection and/or another data values transmission link, and/or indirectly, in particular, with the aid of a car-2-car connection via at least one third vehicle and/or with the aid of a data values transmission medium.

11. The device of claim 9, wherein the arrangement for operating the at least one first automated vehicle is configured so that a potential transition from an automated operation of the at least one first automated vehicle to a manual operation of the at least one first automated vehicle is detected and at least one signal is generated as a function of the received data values, whereby the at least one signal may indicate decision-making options for the further operation of the at least one first automated vehicle.

12. The device of claim 9, wherein the arrangement for operating the at least one first automated vehicle is configured so that at least one trajectory for the at least one first automated vehicle is calculated as a function of the received data values, so that the trajectory is calculated so that the number of transitions from an automated operation of the at least one first automated vehicle to a manual operation of the at least one first automated vehicle is taken into consideration, in particular, is minimized.
